(19) United States
(12) Patent Application Publication
(10) Pub. No.: US 2024/0371355 A1
(43) Pub. Date: Nov. 7, 2024

(54) INFORMATION PROVIDING SYSTEM, METHOD, AND PROGRAM

(71) Applicants: JTEKT CORPORATION, Kariya-shi (JP); connectome.design Inc., Tokyo (JP)

(72) Inventors: Hiroki UMEZAWA, Nagoya-shi (JP); Yoshiyuki SHIBATA, Toyota-shi (JP); Akira SATO, Chiyoda-ku (JP)

(73) Assignees: JTEKT CORPORATION, Kariya-shi (JP); connectome.design Inc., Tokyo (JP)

(21) Appl. No.: 18/291,782

(22) PCT Filed: Aug. 8, 2022
(86) PCT No.: PCT/JP2022/030305

§ 371 Date: Jan. 24, 2024

(30) Foreign Application Priority Data
Aug. 11, 2021 (JP) 2021-131009

(51) Int. Cl. G10L 13/00; G06F 3/01

(52) U.S. Cl. CPC G10L 13/00; G06F 3/012; G06F 3/013

(57) ABSTRACT

Information is provided by a voice taking users into account. An information providing system provides information using a voice. A position direction acquisition unit acquires position information indicating a position of a user, and sight direction information indicating a sight direction that is a direction that a face of the user faces. A storage unit stores, in advance, object position information indicating respective positions of a plurality of objects that may be viewed by the user, and explanation information for explaining each of the objects. An estimation unit estimates the object being viewed by the user based on the position information and the sight direction information of the user, and the object position information. An information output unit outputs the explanation information of the estimated object using the voice.

### CROSS REFERENCE TO RELATED APPLICATIONS

This application is based upon and claims benefit of priority from Japanese Patent Application No. 2021-131009, filed on Aug. 11, 2021, the entire contents of which are incorporated herein by reference.

### BACKGROUND

### Field

The present disclosure relates to an information providing system, a method, and a program.

### Related Art

A device outputs voices for explaining items to explain displayed items to clients.

Patent Literature 1 describes an item display showcase including a CD player and a speaker. In this item display showcase, the CD player plays back a CD that has recorded explanation of each of a plurality of displayed items, and a speaker outputs the played back voice.

Patent Literature 2 describes a technique of disposing near an item a storage medium device that stores data of explanation contents of the item. This storage medium device converts the data of the explanation contents into an audio signal per predetermined time, and outputs the converted audio signal from the speaker included in the storage medium device.

### CITATION LIST

### Patent Literature

Patent Literature 1: JP H8-160897 A
Patent Literature 2: JP H8-221024 A

### SUMMARY

The display showcase described in Patent Literature 1 plays back explanation of a plurality of items in predetermined order. In this case, there is a case where a client cannot immediately listen to explanation of an item that the client is interested in among the plurality of items. The storage medium device described in Patent Literature 2 outputs a voice for explaining an item per predetermined period. According to this technique, in many cases, when moving close to an item, a client listens to from the middle of the explanation of the item for which a voice has already started being output. As described above, the configurations according to Patent Literatures 1 and 2 have problems that it is not possible to provide information using voices taking clients into account.

### Solution to Problem

The present disclosure can be achieved as the following aspect.

(1) One aspect of the present disclosure provides an information providing system. This information providing system provides information using a voice. This information providing system includes: a position direction acquisition unit that acquires position information indicating a position of a user, and sight direction information indicating a sight direction that is a direction that a face of the user faces; a storage unit that stores, in advance, object position information indicating respective positions of a plurality of objects that may be viewed by the user, and explanation information for explaining each of the objects; an estimation unit that estimates the object being viewed by the user based on the position information and the sight direction information of the user, and the object position information; and an information output unit that outputs the explanation information of the estimated object using the voice.

According to this aspect, after the object viewed by the user is estimated, the explanation information of the object is provided to the user. Consequently, it is possible to provide information of the object which the user is supposed to be interested in using a voice.

(2) In the information providing system according to the above aspect, a voice may be output from a voice output device worn on a head of the user. The storage unit may store, in advance, information indicating a virtual position of a sound source associated with each of the objects. The information output unit may output a voice obtained by performing stereophonic processing on the voice indicating the explanation information according to the virtual position of the sound source seen from a current position of the user.

According to this aspect, it is possible to provide the user with the information on the object being viewed by the user while giving the user a sense of presence.

(3) In the information providing system according to the above aspect, the storage unit may store setting information of a visual field to which a range that eye of the user can see is set in advance. The estimation unit may estimate the object being viewed by the user within the range of the visual field set in advance.

According to this aspect, even when the user does not gaze directly at the front of his or her face, it is possible to estimate the object being viewed by the user. The user does not necessarily need to directly face the viewed object. Even when the user does not directly face the viewed object, the user can receive information of the viewed object provided by the voice.

(4) In the information providing system according to the above aspect, when the estimation unit detects that a predetermined time has passed after the object being viewed by the user changes, the information output unit may stop outputting the voice for the explanation information of the object that the user has lastly viewed.

According to this aspect, information that is unnecessary to users is not provided to the users. Consequently, it is possible to efficiently provide information to the users.

(5) The information providing system according to the above aspect may further include: mobile terminals carried by a plurality of the users; and at least one server. Each of the mobile terminals includes the position direction acquisition unit, the storage unit, the estimation unit, and the information output unit. The estimation unit may supply, to the server, visibility data including information for identifying the object estimated to be viewed by the user, information indicating a date and a time of the estimation, and information for identifying the user. The server may include a data accumulation unit that accumulates the visibility data supplied from the estimation unit, and a statistical data generation unit that generates, per object, statistical data indicating a distribution of attributes of the users from attribute data indicating the attributes of the users, and the visibility data, and outputs the statistical data.

According to this aspect, a provider side of the information can think about plans for promoting sales of goods and services for users using statistical data per viewed object.

The aspect of the present disclosure can be achieved by various aspects other than the information providing system. For example, the present disclosure can be achieved by a method of, at a computer carried by a user, providing information using a voice, and a computer program that implements this method.

### BRIEF DESCRIPTION OF THE DRAWINGS

FIG. 1 is a view illustrating a configuration of an information providing system according to an embodiment.

FIG. 2 is a view illustrating a positional relationship between a user and a virtually arranged sound source.

FIG. 3 is a view illustrating an example of data stored in a data accumulation unit according to the embodiment.

FIG. 4 is a flowchart of information providing processing according to the embodiment.

FIG. 5 is a view illustrating another example of data stored in the data accumulation unit.

### DETAILED DESCRIPTION

### A. Embodiment

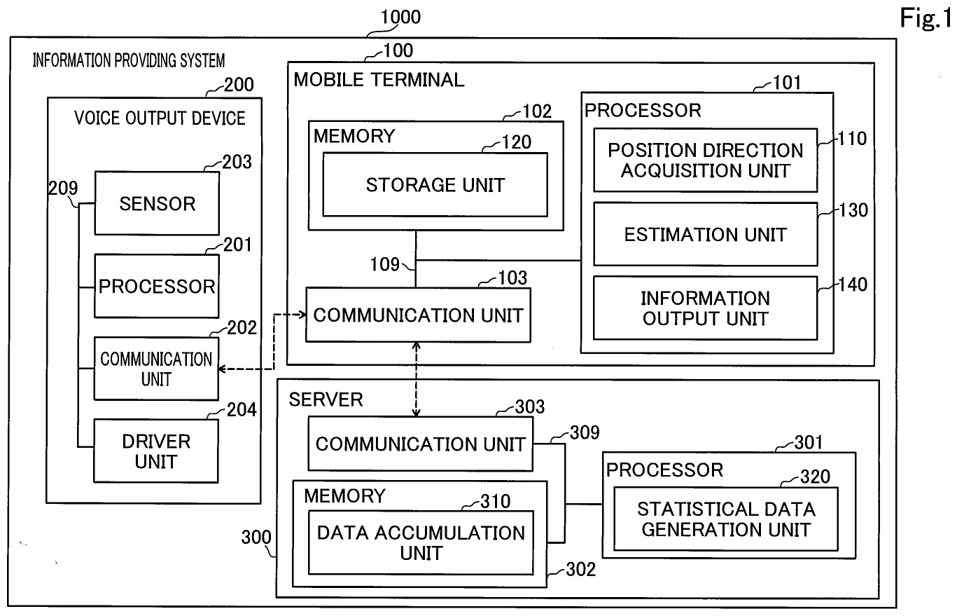

FIG. 1 is a view illustrating a configuration of an information providing system 1000 according to the embodiment. The present embodiment will describe an example where the information providing system 1000 provides information on tourism resources such as historic sites, temples, and shrines, items at tourist attractions, and the like to users who go around the tourist attractions. The information providing system 1000 includes a mobile terminal 100, a voice output device 200, and a server 300.

The mobile terminal 100 is a communication terminal carried by a user. In the present embodiment, the mobile terminal 100 is a smartphone owned by the user. It is assumed that application software for providing information on tourist attractions to the user is installed in the mobile terminal 100. Hereinafter, this application software will be referred to as a guide application. The user can receive information on the tourist attractions provided from the information providing system 1000 by executing the guide application. It is assumed that the user goes around the tourist attractions carrying the mobile terminal 100. The guide application has a function of estimating a user's current position and an object being viewed by the user, and providing information on the tourism resources such as historic sites, temples, and shrines and items at the tourist attractions to the user.

The voice output device 200 is a device that is worn on the user's head, and outputs an audio signal received from the mobile terminal 100. In the present embodiment, the voice output device 200 is wireless earphones owned by the user. It is assumed that the ears of the user are equipped with the earphones when the user goes around the tourist attractions.

Although FIG. 1 illustrates the one mobile terminal 100 and the one voice output device 200 for simplification of description, the information providing system 1000 includes a plurality of the mobile terminals 100 and a plurality of the voice output devices 200. This is because each user who uses the information providing system 1000 carries the mobile terminal 100 and the voice output device 200. The server 300 is an information processing device that accumulates data collected from the plurality of mobile terminals 100, and generates statistical data from the accumulated data.

The mobile terminal 100 includes a processor 101, a memory 102, and a communication unit 103 as hardware components. The memory 102 and the communication unit 103 are connected to the processor 101 via an internal bus 109.

The processor 101 is, for example, a Central Processing Unit (CPU). The processor 101 implements each function of the mobile terminal 100 by executing various programs stored in the memory 102.

The memory 102 includes a Random Access Memory (RAM) and an Electrically Erasable Programmable Read-Only Memory (EEPROM). The memory 102 stores the programs executed by the processor 101, and various data used to execute the programs. Furthermore, the memory 102 is used as a working memory of the processor 101.

The communication unit 103 includes a network interface circuit, and communicates with an external device under control of the processor 101. The present embodiment assumes that the communication unit 103 can communicate with the external device according to Wi-Fi (registered trademark) communication standards. Furthermore, the communication unit 103 includes a Global Positioning System (GPS) receiver, and receives signals from GPS satellites under control of the processor 101. The voice output device 200 includes a processor 201, a communication unit 202, a sensor 203, and a driver unit 204. The communication unit 202, the sensor 203, and the driver unit 204 are connected to the processor 201 via the internal bus 209.

The processor 201 is, for example, a Digital Signal Processor (DSP). The processor 201 controls the communication unit 202, the sensor 203, and the driver unit 204.

The communication unit 202 includes a network interface circuit, and communicates with an external device under control of the processor 201. The communication unit 202 wirelessly communicates with the mobile terminal 100 according to, for example, Bluetooth (registered trademark) standards.

The sensor 203 includes an acceleration sensor, a gyro sensor, and a geomagnetic sensor. For example, as the acceleration sensor, a three-axis acceleration sensor can be used. Furthermore, as an angular velocity sensor, a three-axis acceleration sensor can be used. The sensor 203 measures the acceleration of the voice output device 200 by the acceleration sensor under control of the processor 201. The sensor 203 measures the angular velocity of the voice output device 200 by the gyro sensor under control of the processor 201. The sensor 203 measures a geomagnetic intensity by the geomagnetic sensor under control of the processor 201.

The driver unit 204 converts a supplied audio signal into a sound wave to output under control of the processor 201. An audio signal output by the mobile terminal 100 is supplied to the driver unit 204.

The server 300 includes a processor 301, a memory 302, and a communication unit 303 as hardware components. The memory 302 and the communication unit 303 are connected to the processor 301 via an internal bus 309.

The processor 301 is, for example, a CPU. The processor 301 implements each function of the mobile terminal 100 by executing various programs stored in the memory 302.

The memory 302 includes a RAM, an EEPROM, and a Hard Disk Drive (HDD). The memory 302 stores the programs executed by the processor 301, and various data used to execute the programs. Furthermore, the memory 302 is used as a working memory of the processor 301.

The communication unit 303 includes a network interface circuit, and communicates with an external device under control of the processor 301.

The mobile terminal 100 functionally includes a position direction acquisition unit 110, a storage unit 120, an estimation unit 130, and an information output unit 140.

The position direction acquisition unit 110 acquires information indicating a user's current position. Since the user carries the mobile terminal 100, a current position of the mobile terminal 100 matches with the user's current position. Hence, by acquiring information indicating the current position of the mobile terminal 100, the position direction acquisition unit 110 acquires the information indicating the user's current position. Outdoors, the position direction acquisition unit 110 acquires the information indicating the current position of the mobile terminal 100 based on signals received from the GPS satellites. Indoors, the position direction acquisition unit 110 acquires the information indicating the current position of the mobile terminal 100 based on radio wave intensities received from a plurality of Wi-Fi (registered trademark) base stations.

Furthermore, the position direction acquisition unit 110 acquires information indicating a direction of user's sight. This information is also referred to as sight direction information. In the present embodiment, a direction that the user's face faces is the user's sight direction. The position direction acquisition unit 110 determines the direction that the user's face faces based on a measurement value of the acceleration, a measurement value of the angular velocity, and a measurement value of the geomagnetic intensity received from the voice output device 200. The function of the position direction acquisition unit 110 is implemented when the processor 101 executes the program stored in the memory 102.

The storage unit 120 stores position information of a place that the user is likely to visit. For example, the storage unit 120 stores position coordinates of historic sites, temples, shrines, and the like. Furthermore, the storage unit 120 stores position coordinates of souvenir shops, restaurants, and the like.

Furthermore, the storage unit 120 stores information indicating a position of an object that may become an object viewed by the user. This information is also referred to as object position information. For example, the storage unit 120 stores information of positions of buildings at historic sites. Furthermore, for example, the storage unit 120 stores information of positions of items displayed in a souvenir shop. Furthermore, the storage unit 120 stores explanation information for explaining an object that may become the object viewed by the user. The explanation information is, for example, information for explaining historic sites, temples, shrines, and the like. Furthermore, the explanation information is information for advertising restaurants and souvenir shops, and information for explaining items sold at the souvenir shops.

Furthermore, information indicating a position at which a sound source to be described later is virtually arranged is stored in the storage unit 120 per object that may become the viewed object.

The function of the storage unit 120 is implemented by the memory 102 that stores data of the above position information, explanation information, and information of the position of the sound source. The data of the position information, the explanation information, and the information of the position of the sound source is part of data for executing the guide application stored in the memory 102 when the guide application is installed in the mobile terminal 100.

Furthermore, the estimation unit 130 estimates an object being viewed by the user from the information indicating the user's current position and information indicating the user's sight direction, both of which have been acquired by the position direction acquisition unit 110, and the position information of the object that is stored in the storage unit 120 and the user is likely to look at.

The estimation unit 130 transmits to the server 300 data including information for identifying an estimated object, the information indicating the user's current position, information for identifying the user, and information indicating a date and a time. This data is also referred to as visibility data. In the embodiment, the information for identifying the object is an object ID associated with the object in advance. The position information is information indicating the user's position acquired by the position direction acquisition unit 110. The information for identifying the user is a user ID associated with the user in advance. The date and the time indicate a date and a time at which estimation has been executed.

Furthermore, in some case, the user does not look at any object associated with the object ID in some cases. In this case, the estimation unit 130 transmits to the server 300 the data including the position information of the user, the information for identifying the user, and the information indicating the date and the time. This data is also referred to as position data. The function of the estimation unit 130 is implemented when the processor 101 executes the program stored in the memory 102.

When the estimation unit 130 estimates the viewed object of the user, the information output unit 140 reads the explanation information for explaining the estimated object from the storage unit 120. The information output unit 140 transmits the explanation information as an audio signal to the voice output device 200.

In the present embodiment, the information output unit 140 outputs a voice by stereophony via the voice output device 200. Consequently, the user can hear a sound having expansion and depth from the voice output device 200. Furthermore, the information output unit 140 outputs via the voice output device 200 a voice indicating as if the sound source were at a virtually set position. The position at which the sound source is virtually arranged is set per viewed object. The position at which the sound source is virtually arranged is, for example, a position of an item displayed in a shop or a predetermined position inside or outside a building at a historic site. Consequently, the user can feel as if, for example, the voice of the explanation information were output from the vicinity of the viewed object. Consequently, according to the present embodiment, it is possible to provide information of an object that the user views to the user while giving the user a sense of presence.

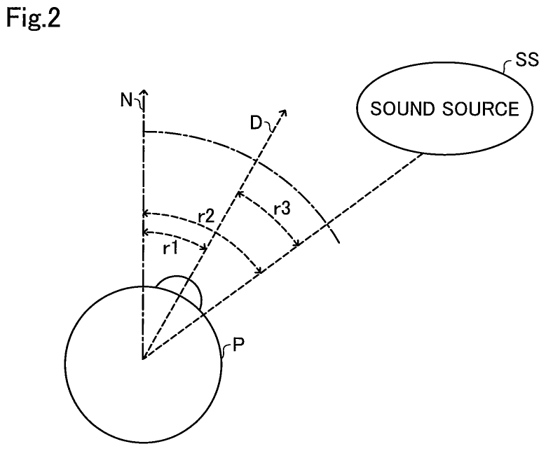

FIG. 2 is a view illustrating a positional relationship between a user P and a virtually arranged sound source SS. FIG. 2 illustrates the user P and the sound source SS from above. The information output unit 140 performs the following processing to output a voice by stereophony. The information output unit 140 reads from the storage unit 120 information of a position at which the sound source SS is virtually arranged for an estimated viewed object. The information output unit 140 obtains a relative angle of a direction of the sound source SS seen from the user P with respect to the sight direction of the user P. Hereinafter, this angle is also referred to as a relative angle.

FIG. 2 assumes that the user P faces a sight direction D. In a horizontal plane, the magnitude of an angle formed by the sight direction D with respect to a reference direction N is assumed to be an angle r1. The reference direction N is, for example, a direction that faces north. The magnitude of an angle formed by the direction of the sound source SS seen from the user P with respect to the reference direction N is assumed to be an angle r2. The information output unit 140 obtains the angle r1 from the sight direction D and the reference direction N. The information output unit 140 obtains the angle r2 from the position of the sound source SS stored in the storage unit 120, the position of the user P, and the reference direction N. The information output unit 140 obtains an angle r3 that is a difference between the angle r1 and the angle r2 as a relative angle. Next, the information output unit 140 obtains a distance between the user P and the sound source SS from the position of the user P and the position of the sound source SS. The information output unit 140 outputs a voice subjected to stereophonic processing based on the obtained relative angle and distance. The stereophonic processing uses, for example, an existing algorithm for generating stereophonic sound, and outputs the voice subjected to the stereophonic processing.

The geomagnetic sensor of the mobile terminal 100 may be used to perform calibration to set the reference direction N. Note that it is assumed that the mobile terminal 100 includes the geomagnetic sensor. For example, immediately after activation of the guide application, a notification is given for the user to match a direction that the user faces and a direction of the mobile terminal 100 held by the user by the hand in a state where the voice output device 200 is worn on the user's head. In the state where the direction of the voice output device 200 and the direction of the mobile terminal 100 are matched, the geomagnetic sensor of the earphones is calibrated from an azimuth acquired from the geomagnetic sensor of the mobile terminal 100.

Furthermore, a change of the position information of the user can be used to estimate the user's sight direction. When, for example, from a history of changes of coordinates indicating the position of the mobile terminal 100 during a certain period, it is detected that the user continuously moves toward the same direction, it may be estimated that a user's line of sight is oriented in the direction. When, for example, from changes of position coordinates of the mobile terminal 100, it is detected that the user moves east on a map, it can be estimated that the sight direction D of the user is east.

The embodiment assumes that a position in a height direction of the user's head and a position in the height direction of the sound source SS are substantially the same. Hence, the information output unit 140 takes only the relative angle and the distance on the horizontal plane into account. However, when the position in the height direction of the user's head and the position in the height direction of the sound source SS are different, the acceleration sensor of the sensor 230 detects an elevation angle or a depression angle. The information output unit 140 may obtain a relative angle and a distance on a vertical plane from the detected elevation angle or depression angle, and output a voice subjected to stereophony processing based on the obtained relative angle and distance.

The function of the information output unit 140 is implemented when the processor 101 executes the program stored in the memory 102.

The server 300 functionally includes a data accumulation unit 310 and a statistical data generation unit 320.

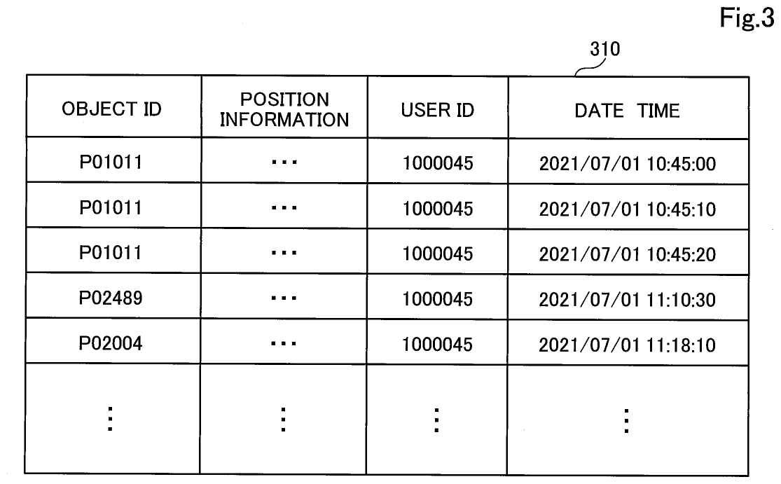

FIG. 3 is a view illustrating an example of visibility data accumulated in the data accumulation unit 310. The data accumulation unit 310 accumulates visibility data supplied from the estimation unit 130 of the mobile terminal 100. In the example illustrated in FIG. 3, the data accumulation unit 310 accumulates the object IDs for identifying estimated objects, the position information indicating the user's positions, the user IDs for identifying users, and the information indicating the dates and the times.

Furthermore, although not illustrated, the data accumulation unit 310 accumulates position data supplied from the estimation unit 130 and indicating the user's positions. Furthermore, the data accumulation unit 310 stores, in advance, data indicating attributes of the users who use the information providing system 1000. This data is also referred to as attribute data. The user's attribute is, for example, a user's age, sex, and occupation. The function of the data accumulation unit 310 is implemented by the memory 302. At, for example, a time of initial activation of the guide application, the user uses the mobile terminal 100 to input information indicating the user's attribute. The input data is stored in the data accumulation unit 310.

The statistical data generation unit 320 generates statistical data from the visibility data and the attribute data stored in the data accumulation unit 310. For example, an object to be viewed is assumed as an item A. The statistical data generation unit 320 may generate statistical data indicating a distribution of attributes of users who have viewed the item A. For example, statistical data is generated which indicates a distribution of each age group of the users who have viewed the item A. Furthermore, statistical data is generated which indicates a distribution of sexes of the users who have viewed the item A.

Furthermore, the statistical data generation unit 320 may obtain per user a period in which each user has continued looking at a specific object from the visibility data stored in the data accumulation unit 310. When the data accumulated in the data accumulation unit 310 indicates being viewed by the user the specific object for a longer time than a preset period, the statistical data generation unit 320 determines that the user has continued looking at the specific object.

For example, a viewed object is assumed as a stone monument B at a historic site. The statistical data generation unit 320 may generate statistical data indicating a distribution of the ages of users who have continued looking at the stone monument B.

Furthermore, the statistical data generation unit 320 may generate statistical data indicating a distribution of the sexes of the users who have continued looking at the stone monument B. Furthermore, the statistical data generation unit 320 may generate statistical data indicating a distribution of time zones during which the stone monument B has been viewed.

For example, an administrator of the information providing system 1000 can think about a plan for promoting sales of items and services for users using statistical data per viewed object.

Furthermore, the statistical data generation unit 320 generates data indicating a history of movement of each of a plurality of users during a set period from position data accumulated in the data accumulation unit 310. Consequently, the administrator of the information providing system 1000 can use statistical data related to a history of users' movement when thinking about the plan for promoting sales of items and services for the users.

The function of the statistical data generation unit 320 is implemented when the processor 301 executes the program stored in the memory 302.

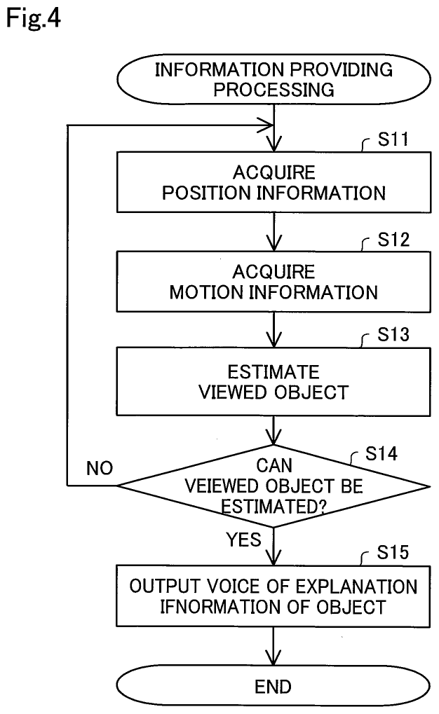

FIG. 4 is a flowchart of information providing processing where the information providing system 1000 provides information to the user via the mobile terminal 100. It is assumed that the mobile terminal 100 starts the information providing processing at a determined time interval. For example, the mobile terminal 100 starts the information providing processing every 10 seconds.

In step S11, the position direction acquisition unit 110 acquires position information of the mobile terminal 100. More specifically, the position direction acquisition unit 110 first acquires position coordinates indicating a current position of the mobile terminal 100 based on GPS signals received from the GPS satellites. When the position direction acquisition unit 110 cannot receive the GPS signals, the position direction acquisition unit 110 acquires the position coordinates indicating the current position of the mobile terminal 100 based on radio wave intensities received from a plurality of Wi-Fi (registered trademark) base stations.

In step S12, the position direction acquisition unit 110 acquires motion information of the user. More specifically, the position direction acquisition unit 110 instructs the voice output device 200 to measure an acceleration, an angular velocity, and a geomagnetic intensity. In response to this instruction, the processor 201 of the voice output device 200 causes the sensor 203 to measure the acceleration, the angular velocity, and the geomagnetic intensity. The processor 201 of the voice output device 200 transmits measurement values of the acceleration, the angular velocity, and the geomagnetic intensity acquired from the sensor 203 to the position direction acquisition unit 110 of the mobile terminal 100.

The position direction acquisition unit 110 determines whether or not the user is gazing at something based on the measurement values of the acceleration and the angular velocity received from the voice output device 200. When, for example, the measurement value of the acceleration satisfies a predetermined condition, and the measurement value of the angular velocity satisfies a predetermined condition, the position direction acquisition unit 110 determines that the user is gazing at something.

When determining that the user is gazing at something, the position direction acquisition unit 110 determines the user's sight direction from the measurement values of the acceleration, the angular velocity, and the geomagnetic intensity. The position direction acquisition unit 110 supplies information indicating the specified user's sight direction to the estimation unit 130. On the other hand, when determining that the user is not gazing at anything, the position direction acquisition unit 110 notifies the estimation unit 130 of this determination.

In step S13, the estimation unit 130 estimates an object being viewed by the user. The estimation unit 130 estimates the object being viewed by the user from the information indicating the user's current position acquired by the position direction acquisition unit 110, the user's sight direction specified by the position direction acquisition unit 110, and the position information of the object that is stored in the storage unit 120 and the user is likely to look at.

Furthermore, when there is no data of the object registered in the storage unit 120 in the user's visual direction, the estimation unit 130 determines that the viewed object cannot be estimated.

On the other hand, when the position direction acquisition unit 110 gives a notification that the user is not gazing at anything, it is determined in step S13 that the estimation unit 130 cannot estimate the viewed object.

In step S14, in a case where the viewed object can be estimated (step S14; YES), the estimation unit 130 supplies the information indicating the estimated object to the information output unit 140. Furthermore, the estimation unit 130 transmits visibility data to the server 300.

On the other hand, in a case where the viewed object cannot be estimated (step S14; NO), the estimation unit 130 transmits position data to the server 300. Subsequently, the information providing processing is finished.

In step S15, the information output unit 140 outputs the explanation information of the object estimated by the estimation unit 130 using a voice. First, the information output unit 140 reads from the storage unit 120 the explanation information of the estimated object and information of a virtual position of a sound source set to the estimated object. The information output unit 140 obtains a relative angle that is a relative angle of a direction of the sound source seen from the user with respect to the user's sight direction, and a distance between the user and a position at which the sound source is virtually arranged for the estimated viewed object. The information output unit 140 computes an output value of the voice to output an audio signal indicating the explanation information as a stereophonic sound based on the obtained relative angle and distance. The information output unit 140 supplies the audio signal of the computed output value to the voice output device 200. Hence, the voice output device 200 outputs the voice of the explanation information. The above is a series of flow of the information providing processing of the information providing system 1000.

As described above, according to an aspect of the embodiment, the information providing system 1000 estimates an object being viewed by the user, and then provides explanation information of the object to the user. Consequently, the user can immediately obtain information on the object of interest. As described above, it is possible to provide information of the object that the user is supposed to be interested in using the voice.

### B. Other Embodiments

### B1. Other Embodiment 1

In the embodiment, an object in the user's sight direction has been estimated as an object being viewed by the user. Alternatively, the viewed object of the user may be estimated as follows. Visual field setting information is stored in the storage unit 120 in advance. The visual field setting information is information to which an effective visual field is set in advance. For simplification of description, it is assumed that a visual field range of vision of both eyes is set. The set visual field may include, for example, only a center visual field. Alternatively, the set visual field may include the center visual field and the effective visual field. Furthermore, alternatively, the set visual field may include the center visual field, the effective visual field, and a range of part of a peripheral visual field. In this case, for example, a visual field in a horizontal direction may be set to a range of 30 degrees to both sides about a fixation point. A visual field in a vertical direction may be set to a range of 30 degrees to an upper side and a lower side about the fixation point.

The estimation unit 130 estimates an object being viewed by the user from the information indicating the user's current position acquired by the position direction acquisition unit 110, the visual field setting information, and the position information of the object that is stored in the storage unit 120 and the user is likely to look at.

According to this embodiment, even when the user's face does not directly gaze at the front, the estimation unit 130 estimates the object being viewed by the user within the set visual field range. The user does not necessarily need to directly face a viewed object. Consequently, the user can receive information of the viewed object provided by a voice while relaxing taking a natural posture.

### B2. Other Embodiment 2

In the embodiment, when an object being viewed by the user is estimated, a voice of explanation information starts being output. While the voice is output, the viewed object of the user may change. Hence, the mobile terminal 100 may employ the following configuration.

The position direction acquisition unit 110 acquires the user's position and the user's sight direction per determined time after the voice starts being output, and supplies the acquired position information and sight direction information to the estimation unit 130. The estimation unit 130 stores in the information output unit 140 a time at which the voice has started being output. The estimation unit 130 determines that the viewed object of the user has changed in a case where the user's position has changed or the user's sight direction has changed. The estimation unit 130 causes the information output unit 140 to stop outputting the voice when detecting that a predetermined time has passed since the change of the viewed object of the user.

Thus, by stopping outputting the voice of the explanation information of the object that the user has stopped looking at, information that is unnecessary for the user is not provided to the user. Consequently, it is possible to efficiently provide the information to the user.

Furthermore, the estimation unit 130 may transmit to the server 300 data including information indicating that the output of the voice has been stopped in the middle, information for identifying an object that is lastly viewed, and the information for identifying the user. Furthermore, even in a case where the output of the voice is not stopped in the middle, the estimation unit 130 may notify the server 300 of this case. In this case, the estimation unit 130 may transmit to the server 300 data including information indicating that the output of the voice has been completed until the end, the information for identifying an object that is lastly viewed, and the information for identifying the user. This data is also referred to as output history data.

When the voice is stopped in the middle, the estimation unit 130 may supply following data to the server 300. The estimation unit 130 obtains a time period from a time at which the information output unit 140 has started outputting a voice of explanation information on a last viewed object to a time at which the information output unit 140 has stopped outputting the voice. It is assumed that the storage unit 120 stores, per viewed object, information indicating a time period required to output the voice of the explanation information until the end. The estimation unit 130 obtains a rate of a time during which the voice of the explanation information of the last viewed object has been actually output with respect to a time required to output the voice until the end. The estimation unit 130 transmits to the server 300 the accumulated output history data including the information indicating that the output of the voice has been stopped in the middle, the obtained rate, the information for identifying the lastly viewed object, and the information for identifying the user.

The data accumulation unit 310 of the server 300 accumulates the output history data supplied from the estimation unit 130. The statistical data generation unit 320 may generate, from the accumulated output history data, for example, statistical data indicating a distribution of attributes of users who have viewed a specific item and listened to a voice of explanation information of this item until the end. Furthermore, the statistical data generation unit 320 may generate, from the accumulated output history data, statistical data indicating a distribution of attributes of users who have viewed a specific item, yet have not listened to a voice of explanation information of this item until the end.

Furthermore, when the voice is stopped in the middle, the estimation unit 130 estimates a new viewed object, and supplies information indicating the estimated new viewed object to the information output unit 140. In response to this supply, the information output unit 140 starts outputting a voice on explanation information of the new viewed object.

### B3. Other Embodiment 3

The embodiment has described the example where the position direction acquisition unit 110 acquires the information indicating the current position of the mobile terminal 100 indoor based on the radio wave intensities received from the plurality of Wi-Fi (registered trademark) base stations. Alternatively, the position information of the mobile terminal 100 may be acquired indoor as follows. It is assumed that the mobile terminal 100 includes a geomagnetic sensor. In this case, the position direction acquisition unit 110 may acquire the position information of the mobile terminal 100 using the geomagnetic sensor.

Furthermore, alternatively, the position direction acquisition unit 110 first acquires the position information of the mobile terminal 100 based on the radio wave intensities received from the Wi-Fi (registered trademark) base stations. When the position direction acquisition unit 110 cannot acquire the position information, the position direction acquisition unit 110 may acquire the position information of the mobile terminal 100 using the geomagnetic sensor.

The embodiment has described the example where the position direction acquisition unit 110 uses the GPS to acquire the current position of the mobile terminal 100 outdoor. Alternatively, the position direction acquisition unit 110 may use other satellite positioning systems such as a quasi-zenith satellite system. Furthermore, alternatively, the position direction acquisition unit 110 may acquire the current position of the mobile terminal 100 using the GPS and the quasi-zenith satellite system.

### B4. Other Embodiment 4

The embodiment has described the example where the voice of the explanation information of the object estimated to be viewed by the user is output. Furthermore, the mobile terminal 100 may have a following function. The estimation unit 130 determines whether or not the user is in a preset area based on the position information of the mobile terminal 100 acquired by the position direction acquisition unit 110. The information output unit 140 outputs a voice of preset explanation information of a place of the user.

For example, the estimation unit 130 determines that the user is in the preset area near a souvenir shop or a restaurant. The information output unit 140 outputs a voice of information for advertising the souvenir shop or the restaurant. It is assumed that a position at which the sound source is visually arranged is set at an entrance of the souvenir shop or the restaurant. In this case, the estimation unit 130 determines whether or not the user has faced the entrance of the souvenir shop or the restaurant at which the sound source is virtually arranged from the information indicating the user's sight direction acquired via the position direction acquisition unit 110. Furthermore, the estimation unit 130 transmits to the server 300 the position information of the user, the information for identifying the user, the information indicating the date and the time, and information indicating whether or not the user has responded to the explanation provided by the voice.

The data accumulation unit 310 of the server 300 accumulates the data supplied from the mobile terminal 100. The statistical data generation unit 320 may generate, for example, statistical data indicating a distribution of attributes of users who have responded to a voice. Alternatively, the statistical data generation unit 320 may generate statistical data indicating a ratio of users who have responded to the voice per time zone.

### B5. Other Embodiment 5

The estimation unit 130 may further include a component that acquires information indicating a user's purchase history. For example, it is assumed that the user pays a price of an item or a service by electronic money using the mobile terminal 100. Alternatively, it is assumed that the user pays the price of the item or the service by a credit card using the mobile terminal 100. In this case, the estimation unit 130 of the mobile terminal 100 may transmit to the server 300 purchase history data including the information for identifying the user, information for identifying an item purchased by the user, a purchase date and time of the item, the number of purchased items, and a purchase amount. The data accumulation unit 310 of the server 300 accumulates the data supplied from the mobile terminal 100.

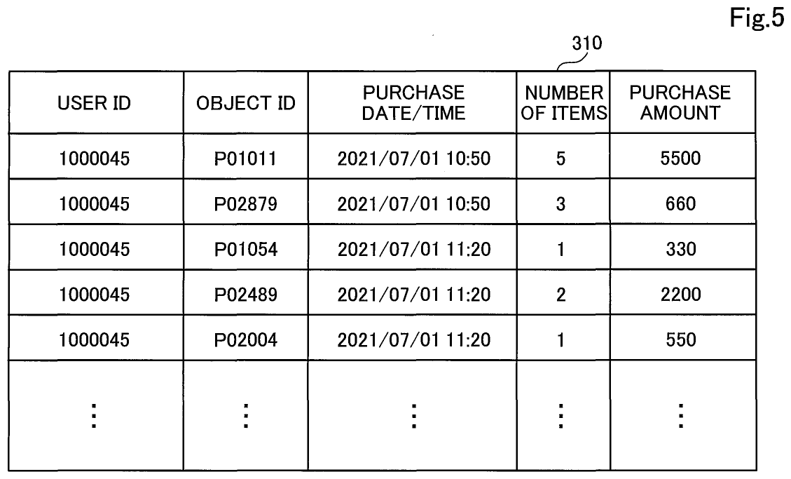

FIG. 5 is a view illustrating an example of the purchase history data accumulated in the data accumulation unit 310. In the example illustrated in FIG. 5, the data accumulation unit 310 stores user IDs for identifying users, object IDs for identifying purchased items, information indicating purchase dates and times of items, the numbers of purchased items, and information indicating purchase amounts. The statistical data generation unit 320 may output, for example, statistical data indicating whether or not an item or a service associated with a rate of a time during which a voice of explanation information of a viewed object has been actually output is purchased, from the purchase history data and the visibility data accumulated in the data accumulation unit 310. Furthermore, the statistical data generation unit 320 may output statistical data indicating a purchase amount associated with a rate of a time during which a voice of explanation information of a viewed object has been actually output. The statistical data generation unit 320 may output statistical data indicating a distribution of attributes of users who have purchased a viewed object. Consequently, for example, the administrator of the information providing system 1000 can analyze a consumption trend of users from a user behavior history and purchase history.

The statistical data generation unit 320 of the server 300 may further have a function of analyzing generated statistical data. Furthermore, the statistical data generation unit 320 may analyze data using, for example, a machine learning model.

### B6. Other Embodiment 6

The estimation unit 130 may estimate two or more objects being viewed by the user. For example, the user is looking at two aligned and displayed items. In this case, after outputting a voice of explanation information of one item, the information output unit 140 may output a voice of explanation information of the other item.

### B7. Other Embodiment 7

The embodiment has described the example where the mobile terminal 100 is a smartphone. However, the mobile terminal 100 may be a tablet terminal or a smart watch.

The embodiment has described the example where the voice output device 200 is wireless earphones. However, the voice output device 200 may be earphones connected to the mobile terminal 100 by wires. Alternatively, the voice output device 200 may be a head phone that can communicate with the mobile terminal 100 in a wired or wireless manner. Furthermore, the voice output device 200 may not output a voice by stereophony.

Furthermore, the embodiment has described the example where the voice output device 200 is earphones owned by the user. Alternatively, the voice output device 200 may be earphones or a headphone lent to the user. In this case, the user can borrow earphones or a headphone at, for example, a tourist information center. Furthermore, a device that outputs a voice of explanation information may not be the voice output device 200 that is worn on the user's head. For example, the mobile terminal 100 may output a voice from a speaker built in the mobile terminal 100. In this case, the mobile terminal 100 may not output a voice by stereophony.

Although the embodiment has described the example where the information providing system 1000 includes one server 300, the information providing system 1000 may include two or more servers.

The embodiment has described the example where the mobile terminal 100 includes the storage unit 120. However, not the mobile terminal 100, but the server 300 may include the storage unit 120. In this case, the mobile terminal 100 requests data to the server 300 at a necessary timing. The server 300 provides the data to the mobile terminal 100 in response to this request.

As storage media that record the programs for implementing the functions of the above mobile terminal 100 and server 300, computer-readable recording media including magnetic disks, optical disks, magneto-optical disks, flash memories, semiconductor memories, and magnetic tapes can be used.

Furthermore, means for implementing the functions of the mobile terminal 100 and the server 300 is not limited to software, and part or entirety of the means may be implemented by dedicated hardware. For example, as the dedicated hardware, a circuit represented by a Field Programmable Gate Array (FPGA) or an Application Specific Integrated Circuit (ASIC) may be used.

The embodiment has described the example where the communication unit 103 communicates with the external device according to the Wi-Fi (registered trademark) communication standards. However, the communication unit 103 may communicate with an external device according to other communication standards such as Bluetooth (registered trademark). The communication unit 103 may support a plurality of communication standards.

The present disclosure is not limited to the above-described embodiments, and can be achieved by various configurations without departing from the gist of the present disclosure. For example, technical features in the embodiments corresponding to technical features in each aspect described in Summary can be replaced or combined as appropriate to solve part or all of the above-described problems or achieve part or all of the above-described effects. Furthermore, unless these technical features are described as indispensable in this description, the technical features can be deleted as appropriate.

### REFERENCE SIGNS LIST

100 MOBILE TERMINAL
101 PROCESSOR
102 MEMORY
103 COMMUNICATION UNIT
109 INTERNAL BUS
110 POSITION DIRECTION ACQUISITION UNIT
120 STORAGE UNIT
130 ESTIMATION UNIT
140 INFORMATION OUTPUT UNIT
200 VOICE OUTPUT DEVICE
201 PROCESSOR
202 COMMUNICATION UNIT
203 SENSOR
204 DRIVER UNIT
209 INTERNAL BUS
300 SERVER
301 PROCESSOR
302 MEMORY
303 COMMUNICATION UNIT
309 INTERNAL BUS
310 DATA ACCUMULATION UNIT
320 STATISTICAL DATA GENERATION UNIT
1000 INFORMATION PROVIDING SYSTEM
D SIGHT DIRECTION
P USER
SS SOUND SOURCE
r1, r2, r3 ANGLE

1. An information providing system that provides information using a voice comprising:
a position direction acquisition unit that acquires position information indicating a position of a user, and sight direction information indicating a sight direction that is a direction that a face of the user faces;
a storage unit that stores, in advance, object position information indicating respective positions of a plurality of objects that may be viewed by the user, and explanation information for explaining each of the plurality of objects;
an estimation unit that estimates the object being viewed by the user based on the position information and the sight direction information of the user, and the object position information; and
an information output unit that outputs the explanation information of the estimated object using the voice.

2. The information providing system according to claim 1, wherein
the voice is output from a voice output device worn on a head of the user,
the storage unit stores, in advance, information indicating a virtual position of a sound source associated with each of the objects, and
the information output unit outputs a voice obtained by performing stereophonic processing on the voice indicating the explanation information according to the virtual position of the sound source seen from a current position of the user.

3. The information providing system according to claim 1, wherein
the storage unit stores setting information of a visual field in which a range that can be seen by eye of the user is set in advance, and
the estimation unit estimates the object being viewed by the user within the range of the visual field set in advance.

4. The information providing system according to claim 1, wherein, when the estimation unit detects that a predetermined time has passed after the object being viewed by the user changes, the information output unit stops outputting the voice for the explanation information of the object that the user has lastly viewed.

5. The information providing system according to claim 1, further comprising:
mobile terminals carried by a plurality of the users; and at least one server, wherein
each of the mobile terminals includes the position direction acquisition unit, the storage unit, the estimation unit, and the information output unit,
the estimation unit supplies, to the server, visibility data including information for identifying the object estimated to be viewed by the user, information indicating a date and a time of the estimation, and information for identifying the user, and
the server includes:
a data accumulation unit that accumulates the visibility data supplied from the estimation unit, and
a statistical data generation unit that generates, per object, statistical data indicating a distribution of attributes of the users from attribute data indicating the attributes of the users, and the visibility data, and outputs the statistical data.

6. A method of providing information using a voice by a computer carried by a user, the method comprising:
acquiring, by the computer, position information indicating a position of a user, and sight direction information indicating a sight direction that is a direction that a face of the user faces;
estimating, by the computer, the object being viewed by the user based on the position information and the sight direction information of the user, and object position information set in advance for each of a plurality of objects that may be viewed by the user; and
outputting, by the computer, explanation information of the estimated object using the voice.

7. A program executed by a computer carried by a user, the program causing the computer to implement:
a function of acquiring position information indicating a position of a user, and sight direction information indicating a sight direction that is a direction that a face of the user faces;
a function of estimating the object being viewed by the user based on the position information and the sight direction information of the user, and object position information set in advance for each of a plurality of objects that may be viewed by the user; and
a function of outputting explanation information of the estimated object using the voice.
